(19) United States
(12) Patent Application Publication
(10) Pub. No.: US 2006/0212352 A1
(43) Pub. Date: Sep. 21, 2006

(54) Real time interactive response system and methods

(75) Inventor: Millo Avissar, Jerusalem (IL)

Correspondence Address: RICHARD I. SAMUEL;GOODWIN PROCTER L.L.P, 599 LEXINGTON AVE., NEW YORK, NY, 10022, US

(73) Assignee: Inc2 Webcom Ltd.

(21) Appl. No.: 11/372,407

(22) Filed: Mar. 8, 2006

Related U.S. Application Data
(60) Provisional application No. 60/662,743, filed on Mar. 17, 2005.

(51) Int. Cl. G06Q 30/00

(52) U.S. Cl. 705/14

(57) ABSTRACT

A system and method, is disclosed in which advertisers actively look for potential consumers. This is done with equipment connected to a network capturing information relating to a computer users (potential consumers) network activity. An activity can be composed of a single or multiple user actions. The activity can be any type of user action that can be identified and/or interpreted as the user being a potential direct or indirect sales lead. It is also disclosed that a User Activity Outline (UAO) is formed for the computer user's by populating as many data elements as possible in a data structure with the captured information and other information relating thereto. This other information may be collected from many possible sources. The information can be check for validity and/or edited based on rules and/or the information from the other sources. Next, the system identifies and informs a relevant provider or advertisers in real time about the user and his/her activity. This can be called a Prompt Sales Lead Notification (PSLN). If a relevant advertiser decides to respond to the PSLN, he/she can do so by transmitting a message in real time to the system.

### CROSS-REFERENCE OF RELATED APPLICATIONS

This application claims the benefit of priority of U.S. Provisional Application No. 60/662,743, filed on Mar. 17, 2005, the entire disclosure of which is hereby incorporated by reference as if set forth at length herein.

### BACKGROUND OF THE INVENTION

In a traditional advertising directory paradigm, only potential consumers are actively looking for something (potential providers), while potential providers (advertisers) are passive, after they place their advertisements. There is a need for a system and method which enables advertisers to actively look for something (potential consumers) and possibly present advertisements tailored to a found potential consumer.

### BRIEF DESCRIPTION OF THE INVENTION

In accordance with the system and method, of this invention advertisers actively look for something (potential consumers).

This is done by equipment connected to a network capturing information relating to a computer users (potential consumers) network activity. An activity can be composed of a single or multiple user actions. In some instances the users initiates a search and in other instances certain other activities of the users are interpreted as an indication that he/she is a potential consumer. The activity can be any type of user action that can be identified and/or interpreted as the user being a potential direct or indirect sales lead.

A User Activity Outline (UAO) is formed for the computer user's by populating as many data elements as possible in a data structure with the captured information and other information relating thereto. This other information may be collected from many possible sources. The information can be check for validity and/or edited based on rules and/or the information from the other sources.

Next, the system identifies and informs a relevant provider or advertisers in real time about the user and his/her activity. This can be called a Prompt Sales Lead Notification (PSLN). The notification can be done on the network or by some other means.

If a relevant advertiser decides to respond to the PSLN, he/she can do so by transmitting a message in real time to the system. If the system receives more than one massage in response to a particular UAO the system may, in one embodiment, screen the messages and/or information about the advertiser to establish priorities between the advertisers for purposes of further notification and/or priority of presentation. In any event the system contacts the user providing an advertisement and/or other information relating to one or more of the responding advertisers. The response need not be on the network.

The user may respond to the advertisement and/or other information by indicating which of the advertisers he/she wishes contact with.

At this point in the method there are many alternative options available. In one embodiment the system can be an intermediary to the contact or in another embodiment the system can help establish a direct contact.

The advertisers can be charged upon one or several of the following events:
1. Display of an opportunity to the advertisers
2. Sending of advertiser's response to the user
3. Advertiser's selection by the user.
4. Advertiser's deal closure with the user
5. Advertiser's receiving a payment from the user

### DESCRIPTION OF THE DRAWINGS

The present invention can be better understood from the Detailed Description of the Invention, taken in conjunction with the following drawings. It should be apparent to those skilled in the art that the described embodiments of the present invention provided herein are merely exemplary and illustrative and not limiting. All features disclosed in the description may be replaced by alternative features serving the same or similar purpose, unless expressly stated otherwise. Therefore, numerous other embodiments of the modifications thereof are contemplated as falling within the scope of the present invention and equivalents thereto.

FIG. 1 is a block diagram of a system which can perform a method in accordance with one or more embodiments of this invention;

FIG. 2 is a flow chart of Step 1 of a method in accordance with one embodiment of this invention;

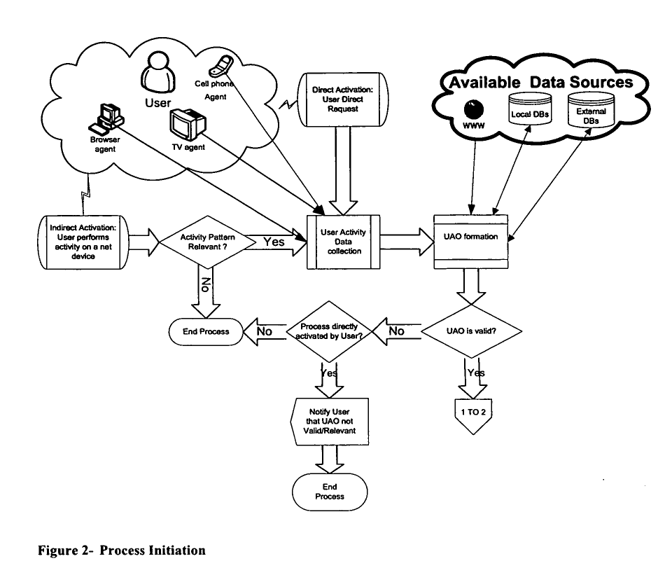

FIG. 3 is a flow chart of Step 2 of a method in accordance with one embodiment of this invention;

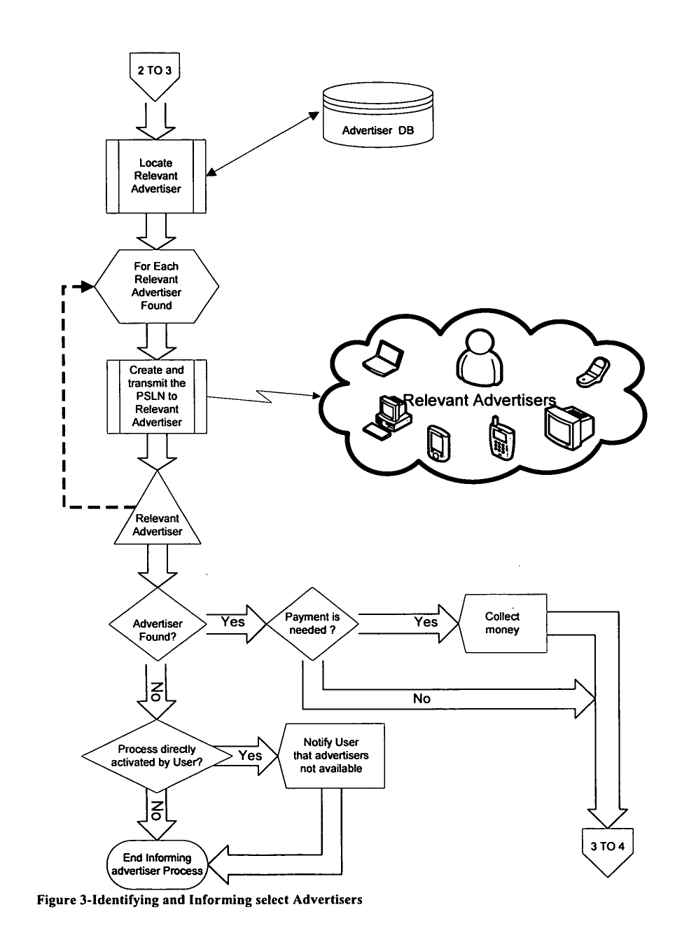

FIG. 4 is a flow chart of Step 3 of a method in accordance with one embodiment of this invention;

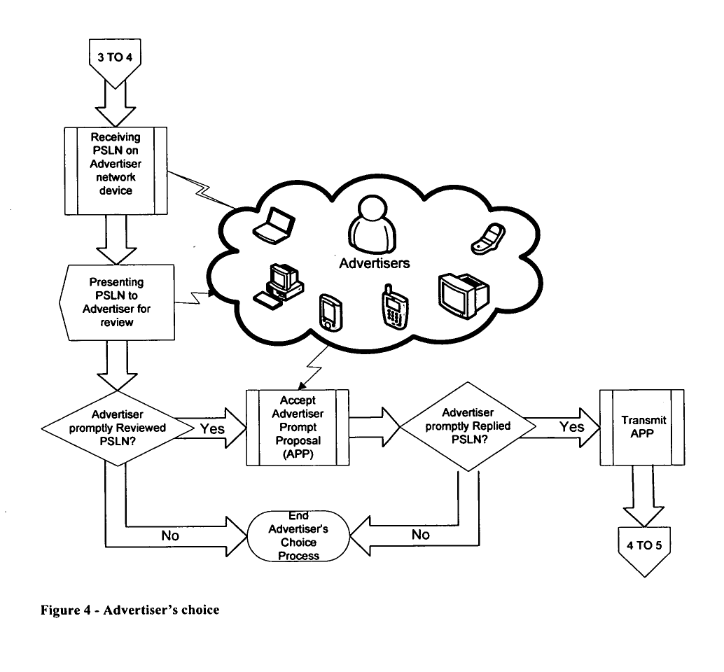

FIG. 5 is a flow chart of Step 4 of a method in accordance with one embodiment of this invention;

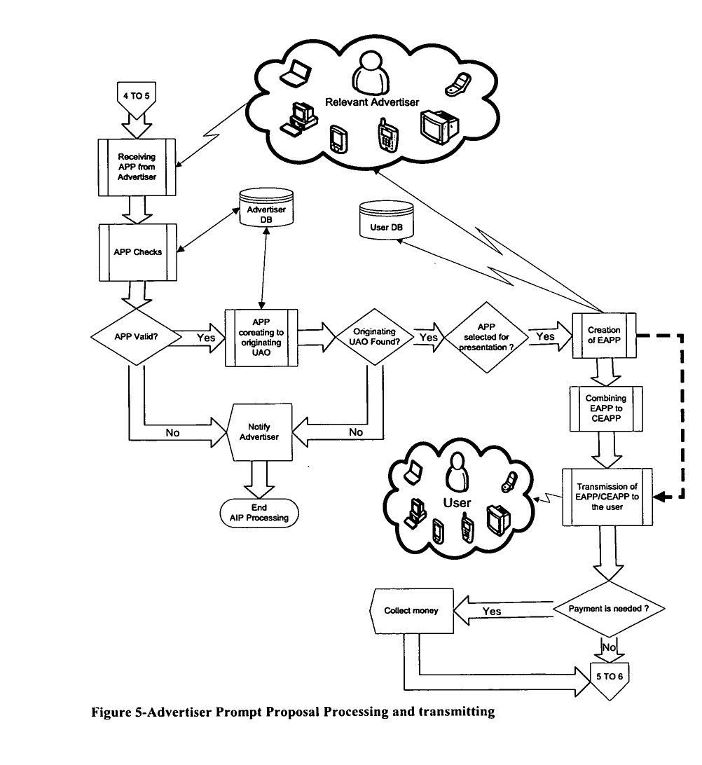

FIG. 6 is a flow chart of Step 5 of a method in accordance with one embodiment of this invention; and

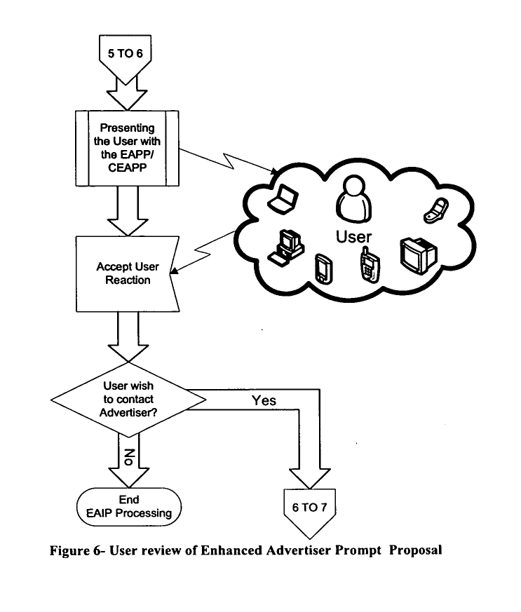

FIG. 7 is a flow chart of Step 6 of a method in accordance with one embodiment of this invention;

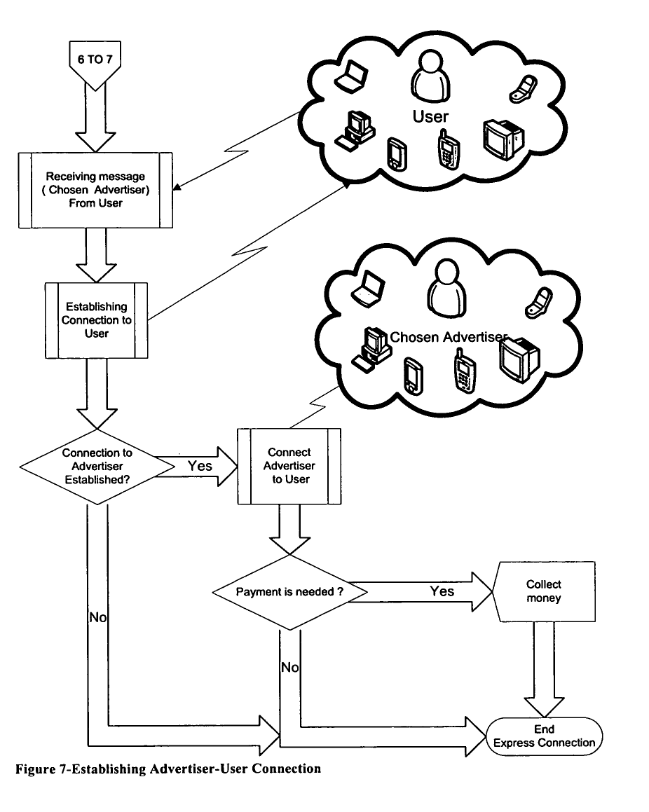

### DETAILED DESCRIPTION OF THE INVENTION

The system and method provide a business opportunity to registered service and/or product providers (advertisers) by informing one or more of the registered advertisers in real time upon the occurrence of an activity initiated by a user (potential consumer), indicating the need for their service/products, and allows the advertisers in real time to contact, interact and/or communicate with the user.

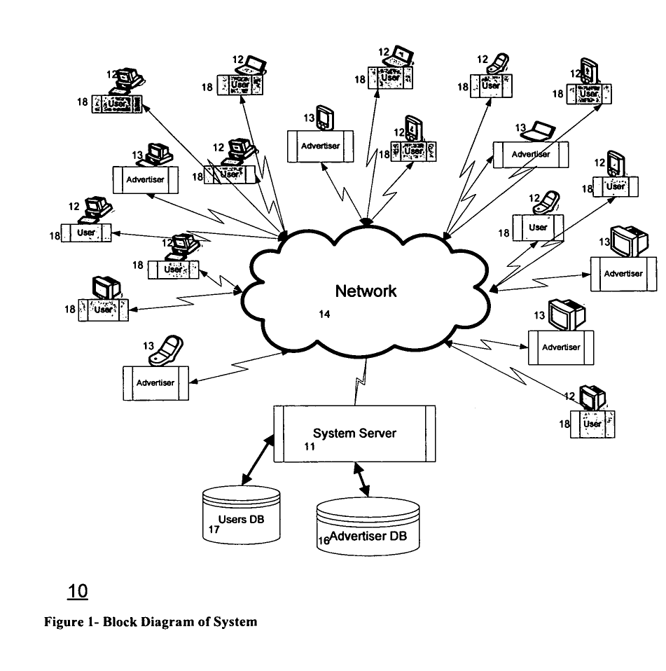

The system 10, see FIG. 1, includes a system server 11, a plurality of user terminals (devices) 12, a plurality of advertiser terminals 13 and a network 14 through which each of the above can communicate.

Prior to a service and/or product provider participation in the system 10 it is registered as an advertiser and information relevant to it is entered in an advertiser database 16 which is on or associated with the system server 11. The information can include payment terms between the advertiser and the owner of the system.

The advertiser database 16 is an integral part of the system and method and may include some or all of the following information: advertiser identification, authentication, contact information, services provided, preferred opportunities and payment information (prepaid or postpaid).

Users can provide information relevant to them which can be stored in a user database 17 for registered users. Information for transient one-time users may not be stored in the data base.

A user can access the system 10 through any suitable device 12 some of which are listed below. Any device for accessing the system server 11 is included in the term computer as used herein. Such devices include:
1. A terminal device for access to the network 14, such as the internet. Such terminals include a PC/Laptop. These terminals can use a web browser, net application, button on a toolbar or other application.
2. Mobile device such as mobile telephone, PDA, etc. These devices can use SMS request, WAP or web browser
3. TV (set top box)
4. Telephone

Depending on the technology and architecture on which the system 10 is implemented:
Process initiation can be accomplished by modules which reside at one or more network locations to identify and capture user activities. Such locations can be:
   Directory net site (can be a web site or a telephone terminal)
   Search Engine net server
   Electronic bulletin board
   User net device 12

The system 10 and method can be considered as a modified interactive electronic market paradigm. While in a traditional electronic market paradigm, only the potential consumers are actively looking for something (potential providers), while users are passive, after they place their advertisements. In this system and method, the providers are enabled to actively look for something (potential consumers). In some instances the users initiates a search for a particular item and is considered a direct lead and in other instances certain activities of a user are interpreted as an indication that he/she is a potential consumer, being an indirect lead.

The activity can be any type of user action that can be identified and/or interpreted as a potential direct or indirect sales lead.

For example—An online search for a specific product or service indicates and provides a clear sales lead. The search can be done using any of the known search services such as:
Search engine (such as MSN, Google, Yahoo), for both local and general search purposes.
General guided directory web site (such as superpages.com or smartpages.com).
Web site serving as a guided directory.

An example of a direct lead is:
User activates a search engine entering “Plumber Richmond VA” as a search string
User accesses the 1st search results
User returns to the search list
User accesses 4th search result
User activates the search engine again looking for “Pipe Layer Richmond VA”.

An indirect sales lead can be deduced from a variety of activities, such as:
The purchase of a product that requires supplemental products and services. For example, purchase of computer may serve as a sales lead for computer peripherals hardware suppliers, software product providers and computer technicians.
Information update such as change of physical address may indicate a person or a company has changed their location and provides an indirect sales lead to a variety of service provider such as gardeners, roofers, electricians, etc.
Advertising an apartment for sale on a digital real-estate buy-and-sell board may serve as an indirect sales lead to real-estate agents, movers and lawyers specializing in real-estate contracts.

An example of an indirect lead is:
User activates a search engine entering “Restaurant in New York” as a search string
User is identified as a foreign individual from the device used to access the search engine
System concludes that user is a visitor and can require certain goods and services visitors often purchase.

The registered advertiser can be charged upon one or several of the following events:
1. Upon display of opportunity to the registered advertiser
2. Upon advertiser's appearance on the user's displayed list
3. Upon advertiser's selection by the user.
4. Upon advertiser's deal closure with the user
5. Upon advertiser receiving a payment from the user
   Step 1—Process Initiation—See FIGS. 1 & 2

Initiation of the system/method after a triggering event, receive by the system server 11.

Triggering Event

Certain data from a user device 12 detected at the system server 11.

Main Functions (at System Server)

Process Activation

User Activity Data collection

User Activity Outline Formation

Process Activation

When a user manipulates a user device 12 performing particulate activity, and data relating thereto is sensed at the system server 11 the system 10 can be activated in one of the following ways:
Direct User Activation—The data indicates that the network user is requesting the activation of the system 10 in various ways, including:
   Accessing a specific network location (such as a web site or telephone terminal)
   Activating a specific application
Indirect User Activation—when the data indicates that the network user is performing any kind of activity on a user device 12. The system identifies the user's actions on such user device 12 (such as computer, PDA, TV, mobile device, telephone, etc). Each action made by the user on the particular user device 12 is examined to identify a relevant activity pattern. Once a set of actions is identified as a relevant activity pattern (for example, activation of a search engine or accessing a Directory), the process continues.
   User Activity Data Collection

In the next stage in process initiation, the system server 11 collects information to populate as many data elements as possible in the data structure called User Activity Outline (UAO). This information may be collected from many possible sources, such as:
The user device 12 used by the user which could provide, among other things, the location the user is performing the activity from
A network server accessed by a user device 12
Relevant internal and external data which can be from databases such as user database 17

In some instance an agent 18 or the like is provided on one or more user devices 12 or other data sources.

User Activity Outline Formation

This part of the process, described below, is part of any well designed network system but need not be included in a system in order for such system to be within the scope of this invention. It is included here for purposes of completeness.
UAO data element checks—The system may check the integrity and completeness of the relevant UAO data elements, for example:
Actual user activation—the system server 11 may verify it was not activated as a result of an automated process such as a computer virus. Such integrity and completeness violations will result in defining the UAO as Invalid UAO
If the UAO contains address data, the system server 11 may verify the address data provided constitutes as a valid postal or physical address according to local rules (such as USPS standards).
Such integrity and completeness violations are not considered critical as it may not be relevant or may be completed or corrected as part of the UAO Edits.

If the system server 11 identified an invalid UAO, for example, a UAO that was created by an automated process (virus), there is no point in further processing the UAO:
If the invalid UAO was directly activated, the system server 11 will notify the particular user device 12 that the UAO was identified as invalid and the process will end.
If the invalid UAO was indirectly activated, the process will end.
UAO data Edits(analysis)—Using internal and external data sources, the system server 11 attempts to correct UAO data elements found to be invalid and complete missing UAO data elements that were not available or could not have been defined before such as:
Generation of Unique UAO ID
Address Data Correction
Relevant Provider Type Identification—Identifying of the types of provider that might be interested in such a type of user activity. For example—if the user is advertising an apartment for sale on a real-estate digital buy-and-sell board, real-estate agents, movers and lawyers specializing in real-estate contracts may be interested in a sales lead for this user.
Keywords text deduction done by a lexical analysis rule based program. for example typo corrections.

UAO formation—The system server 11 forms the UAO from all the data elements populated previously after corrections

Output from Step 1

The server system 11 forms a UAO

Step 2—Identifying and Informing Select Advertisers—See FIGS. 1 & 3

Identify and inform relevant advertisers at advertiser terminals 13 about the relevant user activity at it's user device 12.

Activation

By Step 1 completion—receipt of a UAO

Main Functions (Also at System Server 11)

Locating Relevant Advertisers

Informing Relevant Advertisers

Charging Advertiser (optional function)

Locating Relevant Advertisers

The system server 11 searches for relevant registered advertisers in the advertiser database 17. The advertiser database 17 may identify provider type, service type, advertiser's terminal 13 IP address and/or any other appropriate parameters.

If relevant advertisers can not be found in the advertiser database 11, the system server 11 will react as follows:
If the process was directly activated, the system server 11 will notify the relevant user device 12 and the process will end.
If the process was indirectly activated, the process will end.
   Informing Relevant Advertisers

When relevant advertisers are located, for each relevant advertiser, the system verifies that there is a way to promptly interact with the advertiser. The system creates and transmits a Prompt Sales Lead Notification (PSLN) to each of the relevant advertisers terminal 13 based on the UAO. The PSLN, in most cases will not include sufficient information to identify the originating user or his/her device 12.

The PSLN can be a voice message, RSS feed, SMS or any other message form technologically possible for prompt transmission. It may also be a Screen Display to a human operator who is promptly contacting the advertiser.

Charging Advertiser

Depending on the advertiser's registration agreement with the system owner, the system server 11 may charge the advertiser at this stage for the PSLN

Output from Step 2

Prompt Sales Lead Notification (PSLN) to each relevant advertiser terminal 13. Optional charge to the advertiser's account (prepaid or postpaid)

Step 3—Advertiser's Choice—See FIGS. 1 & 4

Enable a relevant advertiser to promptly review the PSLN and choose to reply.

Activation

Advertiser Terminal 13 Receiving PSLN

Main Functions (at Advertiser Terminal 13)

PSLN Review by Advertiser

Advertiser Response

PSLN Review by Advertiser

Upon receiving the PSLN, the relevant advertiser may choose to do at least one of the following:
Review the PSLN promptly.
Ignore the PSLN—If this is the advertiser's choice, the process is ended. As far as the method and system is considered, if the advertiser does not respond to the PSLN promptly, it is considered as if the PSLN was ignored or dismissed.
   Advertiser's Response

An advertiser may receive multiple PSLNs in the same time frame. If the advertiser decided to promptly review a specific PSLN, he or she may choose to use one of the following options:
Reply to the PSLN promptly. If the advertiser decides to promptly reply to the PSLN, he/she can do so by transmitting Advertiser Prompt Proposal (APP) from his/her advertising terminal 13 to the system server 11
Not reply the PSLN—If this is the advertiser's choice, the process is ended.
   Output from Step 3

APP—Advertiser Prompt Proposal sent back to the system server 11.

Step 4—Advertiser Prompt Proposal (APP) Processing and Transmitting—See FIGS. 1 & 5

Provide the user with responses from one or more relevant advertisers

General

The system server 11 may receive multiple APPs that were a result of relevant advertisers terminals 13 responding to the particular UAO. Each APP is processed as described below.

Activation

System Server 11 Receiving APP from advertiser terminal 13

Main Functions (at System Server)

APP Checks

APP correlating to originating UAO and or the PSLN

Comparison to other APP relating to the same originating UAO, if any. Determine if an APP is to be presented to the user and its priority in presentation

if selected for presentation to user, creation of EAPP (Enhanced Advertiser Prompt Proposal)

Optionally combining selected EAPPs to provide a CEAPP (Combined Enhanced Advertiser Prompt Proposal)

Transmission of EAPP and/or CEAPP to the user device 12

Charging the advertiser (optional function)

Advertiser Prompt Proposal (APP) Checks

The system server 11 receives the APP transmission and promptly checks the integrity and completeness of the APP. For example:
Actual advertiser activation (authentication)—the system verifies that the APP was received from an actual advertiser and not a result of an automated process such as computer virus.

Such integrity and completeness violations will result in defining the APP as an Invalid APP

If the system identified APP to be invalid, the processing of the APP ends.

Advertiser Prompt Proposal correlating to Originating UAO

In order to identify the user to which the APP is addressed, the system matches the APP to the originating UAO.

If the system is unable to match the APP to the originating UAO, the system may inform the advertiser at its advertiser terminal 13 that the PIP is no longer relevant and the processing of the APP ends.

Comparison to Other APP

In some instances it is desired to select a reduced number of APP to be shown to the user. In order to do so the system server 11 will compare the APP to other APP's relating to the same originating UAO, if more then one has already received. The system server 11 will determine if an APP is to be presented to the user and its priority in presentation. The selection is based on the APP data as well as information from other available data sources (such as Advertiser ratings by other users)

Creation of EAPP

The system server 11 creates the EAPP. The EAPP is based on the APP data as well as information from other available data sources (such as Advertiser ratings by other users).

Combining Selected EAPPs to Create a CEAPP (Combined Enhanced Advertiser Prompt Proposal)

Optionally selected one or more EAPP can be combined to a CEAPP

Transmission of EAPP and/or CEAPP to the User

The EAPP and/or CEAPP are transmitted to the relevant user device 12 Charging Advertiser

Depending on the advertiser's registration agreement with the system owner, the system may charge the advertiser at this stage for transmitting the EAPP

Output from Step 4

EAPP or CEAPP—sent to the relevant user device 12

Optional charge to the advertiser's account (prepaid or postpaid)

Step 5—User Review and Reaction to EAPP or CEAPP—See FIGS. 1 & 6

Present to user with the EAPP or CEAPP for review and reaction

Activation (at User Site)

Receiving EAPP or CEAPP

Main Functions

Presenting the user with the EAPP or CEAPP

User sending Reaction to EAPP or CEAPP, to the system server 11 and or a particular advertiser.

Presenting the User with the EAPP or CEAPP

If the user directly activated the system, the EAPP or CEAPP or a summary thereof is presented to the relevant user device 12.

If the system was indirectly activated, depending on the architecture of the relevant user's device 12, the system server 11 might first obtain user approval for presenting the EAPP or CEAPP or a summary thereof.

The presentation to the user device 12 may include options to request additional information, this information could be:
Advertiser's reputation based on other users' review, qualifications and history of past performance.
Additional advertising material including: text, image, video, voice message or any other media file.
Payment options for one or more advertisers.
   User Reaction

If the user is interested in further communication with the system server 11 or one or more advertisers, the system server 11 may be configured to allow the particular user device 12 to communicate with the system server 11 and/or one or more advertisers terminals 13.

Output from Step 5

A user's device 12 manipulation and/or a message from the user device 12, the system server 11 and or one or more advertisers terminals 13.

Step 6—Establishing Advertiser-User Connection—See FIGS. 1 & 7

Establish connection between the user and advertiser

Activation

User choosing to communicate with a specific advertiser based on the EPIP

Main Functions

Establishing Advertiser-User Connection

Charging advertiser

Establishing Advertiser-User Connection

When the user chooses to communicate with a specific advertiser, the system server 11 now establishes the connection.

Establishing the connection can be done in various ways, such as:
Invoking a communication system on the user's device 12 (e.g., VOIP system, Messenger, etc.).
Informing the advertiser of the user's communication device 12 and ID (e.g., Mobile telephone and the Telephone Number, specific VOIP software system and the User ID on that system, etc.)
Using an intermediation tool (such as telephone exchange, call-back system, etc.) to establish a conference (text/audio/video)

The user may also have the option to establish connection to more than one advertiser simultaneously.

Charging Advertiser

The system server 11 may charge the advertiser's account (prepaid or postpaid) upon the advertiser's selection by the user. This charge is triggered by the establishment of the User-Advertiser interaction

Output from Step 6

Connection between the User and an advertiser

Optional charge to the advertiser's account (prepaid or postpaid)

While various embodiments and individual features of the present invention have been illustrated and described, it would be obvious to those skilled in the art that various other changes and modifications can be made without departing from the spirit and scope of the present invention. As will also be apparent to those skilled in the art, various combinations of the embodiments and features taught in the foregoing description are possible and can result in preferred executions of the present invention. Accordingly, it is intended that such changes and modifications fall within the scope of the present invention as defined by the claims appended hereto.

### Appendix I—Glossary

Communication network—Any type of network allowing communication between one, two or more participants, regardless of the platform and architecture or combination of platforms and architectures.

Communication network device—the device used to access the communication network, such as computer, phone, PDA, TV, a terminal or a mobile device.

A system operates in Real-time if it functions in a timeframe normal for person to person interaction over the appropriate medium such as internet and/or telephone.

What is claimed is:

1. A method, of advertising to a potential customer who is using a computer connected to a network in which one or more registered advertisers each having an advertisers terminal connected to said network can tailor an ad to said potential customer before said ad is presented to said potential customer; the method including:
providing a system server;
storing information relating to each of said one or more registered advertisers on a computer readable medium associated with said system server;
capturing information relating to said potential customer's use of said computer on said network;
employing at least some of said captured information and some or all of said information relating to said one or more registered advertisers to identify one or more of said registered advertisers as relevant advertisers for said potential customer; and
informing one or more of said relevant advertisers, in real time, of said potential customer's activity whereby said one or more of said relevant advertisers can tailor an ad to said potential customer before said ad is presented to said potential customer.

2. The method as defined in claim 1 also including:
providing a data structure;
employing at least some of said captured information to populate as many data elements as possible in said data structure with said captured information and other information to form a user activity outline relating to said potential customer and indicating the nature of said potential customer's activity.

3. The method as defined in claim 1 also including:
providing one or more of said ads and/or other information relating to said one or more relevant advertisers, in real time, to said potential customer.

4. The method as defined in claim 3 in which said providing is done over said network.

5. The method as defined in claim 3 in which said providing is done with said system server being used as an intermediary between said one or more relevant advertisers and said potential customer.

6. The method as defined in claim 5 in which said system server receives ads and/or other information relating to more than one of said relevant advertisers also including:
said system server analyses said ads and/or other information relating to said more than one of said relevant advertisers and information from said computer readable medium to provide a priority among some or all of said more than one of said relevant advertisers for purposes of order or fact of presentation to said potential customer.

7. The method as defined in claim 3 also including:
the potential customer responding to said ads and/or other information by indicating which of said relevant advertisers he/she wishes contact with.

8. The method as defined in claim 7 also including:
establishing contact between one or more of said relevant advertisers and said potential customer thorough an intermediary.

9. The method as defined in claim 3 also including:
the potential customer responding to said ads and/or other information by of said establishing direct contact with one or more of said relevant advertisers.

10. The method as defined in claim 1 also including:
charging a particular advertiser upon informing said particular advertiser of said potential customer's activity.

11. The method as defined in claim 3 also including:
charging a particular advertiser upon one or more of the following events, chosen from the group of:
informing said particular advertiser of said potential customer's activity and
providing said ads and/or other information relating to said particular advertiser to said potential customer.

12. The method as defined in claim 7 also including:
charging a particular advertiser upon one or more of the following events, chosen from the group of:
informing said particular advertiser of said potential customer's activity;
providing said ads and/or other information relating to said particular advertiser to said potential customer; and
the potential customer responding to said particular advertiser's ads and/or other information by indicating he/she wishes contact with said particular advertiser.

13. The method as defined in claim 8 also including:
charging a particular advertiser upon one or more of the following events, chosen from the group of:
informing said particular advertiser of said potential customer's activity;
providing said ads and/or other information relating to said particular advertiser to said potential customer;
the potential customer responding to said particular advertiser's ads and/or other information by indicating he/she wishes contact with said particular advertiser; and
establishing contact between said particular advertiser and said potential customer thorough an intermediary.

14. The method as defined in claim 9 also including:
charging a particular advertiser upon one or more of the following events, chosen from the group of:
informing said particular advertiser of said potential customer's activity;
providing said ads and/or other information relating to said particular advertiser to said potential customer; and
the potential customer responding to said particular advertiser's ads and/or other information by establishing direct contact said particular advertiser.

15. The method as defined in claim 1 wherein said information captured indicates that said potential customer initiated a search for identifiable goods or services.

16. The method as defined in claim 1 wherein said information captured indicates that said potential customer is engaged in an activity that can be interpreted as an indication that he/she is a potential consumer.
